(19) United States
(12) Patent Application Publication
(10) Pub. No.: US 2012/0070801 A1
(43) Pub. Date: Mar. 22, 2012

(54) Dental implant locating device and method of use.

(76) Inventor: Daniel S. Haghighi, Longview, WA (US)

(21) Appl. No.: 12/887,671

(22) Filed: Sep. 22, 2010

(51) Int. Cl. A61C 13/12; A61C 13/225

(52) U.S. Cl. 433/172

(57) ABSTRACT

An improved method for determining the final position of a prosthetic crown and method for drilling a hole suited for a dental implant in a patient's jawbone includes the use of a spacer device. The spacer device comprises a vertical cylindrical barrel portion that selectively couples to industry-standard drill and receives industry-standard drill bits.

### BACKGROUND

1. Field of the Invention

The present invention relates to a device and a method for properly positioning and aligning a prosthetic crown during dental implant surgery.

2. Description of Related Art

Dental implant surgery, whereby a missing or damaged tooth is replaced by a prosthetic crown and associated implant, fills an important need for many patients who lost or damaged one or more teeth. For many patients, implant surgery begins with removal of a damaged tooth. It is important that the extraction remove the entire tooth—the crown and the root. With the root removed, the next step is to prepare the jawbone for the implant. This begins with opening the gum tissue to expose the bone area where the implant will be placed. There are well-known devices and methods currently employed to extract teeth and prepare the jawbone for implant placement.

Typically, a specialized dental drill and assorted dental drill bits are used to form and increasingly larger hole in the jawbone. Often a series of increasingly larger diameter drill bits are used to slowly and methodically enlarge the hole in the jawbone until the proper diameter is achieved based on the size of the implant Location of this hole is of vital importance, for this hole's position described misally-distally and lingual-buckle and having an angle or offset from vertical will determine the orientation of the implant, which will ultimately determine the location of the prosthetic crown.

Once the implant is placed in the jawbone, the tissue is sutured. Overtime, osseointegration, the process of bone matter inter-fusing with the implant, fuses the implant to the jawbone and thus provides a stable base for the prosthetic crown to affix.

There are many implants available, each designed for a specific application. Most implants are fabricated of titanium, an inert metal proven to be effective at fusing to living bone tissue. One type of common implant is the root form, similar in shape to the root of the replaced tooth and having a surface area designed to promote osseointegration. This root form implant requires a relatively wide and sizable area of a healthy jawbone. However, if the jawbone is not sufficiently healthy, an intermediate bone grafting process may be required prior to implant placement. In other applications the patient's jawbone may be too narrow or otherwise not a good candidate for the root form implant: In such instances a plate form implant may provide a solution for the patient.

The most-common root form implant necessitates an accurate location of a hole in the jawbone so that the final placement of the prosthetic crown positions in such a manner to provide optimal spacing with surrounding teeth and presents a more natural aesthetic appeal to the patient.

Desirably, the drill bit should not wobble or tilt abnormally, particularly when drilling a pilot hole for implant surgery. Rather, it is desired that the drill bit and its drive mechanism be held very steadily and in such a way that the axis of the drill bit itself throughout drilling of the pilot hole substantially coincides with a substantially fixed vertical axis that is parallel to the vertical axes of the teeth adjoining the tooth being replaced.

The prior-art teaches certain methods and devices that, recognizing the importance of a precise location of the pilot hole relative to surrounding (existing or implanted) teeth and an optimal drill angle relative to the jawbone, attempt to locate and position implants.

Those skilled in the art recognize the current teaching in this art include the ITI consensus paper by Buser, D., Martin, W., and Belser, U. entitled “Optimizing esthetics for implant restorations in the anterior maxilla: anatomic and surgical considerations,” Int. J. Oral Maxillofacial Implants, (2004) 19 Suppl. pages 43-61; and also by Buser, D., Martin W. and Belser, U, the article entitled “Surgical considerations for single-tooth replacements in the esthetic zone: standard procedure in sites without bone deficiencies,” published in the ITI Treatment Guide (2007), vol. 1; pages 26-37, published by Quintessence Pub. Co. Ltd. Berlin: The entire disclosures of which are incorporated by reference as if fully set forth herein.

One particularly instructive prior-art publication that teaches the current state-of-the-art in dental implant devices and methods is the United States Patent Application Publication Number 2009/0286201 by Choe published on 19 Nov. 2009: The entire disclosure of which is incorporated by reference as if fully set forth herein.

There is an inherent weakness common to all these aforementioned teachings: The final prosthetic crown placement depends on a precise location of the pilot hole used to establish the implant location. Precisely determining and then executing this pilot hole in a patient's jaw bone is extremely difficult and relies heavily upon the skill and luck of the dentist or surgeon drilling the hole.

The current teaching instructs a dentist or surgeon to measure the existing gap (created by removing the problem tooth) between existing teeth and/or prosthetics, selecting an appropriate sized crown which dictates the size of implant, reconciling the size of the implant possible to place in the bone tissue of the particular patient, calculating the spacing needed to clear the existing dental work (about 1.5-mm on each side of the crown), and then estimating where on the jaw-bone the pilot hole should be placed. Next, the dentist must have a very steady hand, and good guess work as to the precise orientation of the hole using skill and guess work as to the relative placement of the finished prosthetic tooth based on the positioning (misally-distally and buckle-lingual, angulation and distance from neighboring teeth or other structure) to begin the drilling. And the surgeon must repeat this precision touch with each subsequent and larger diameter drill bit.

Thus, there is a need for a tool or device that removes the guesswork and reduces the innate skill required to precisely and repeatedly locate and drill the implant hole in a patient's jawbone. Such a device and associated method should begin with and end with the aesthetic placement of the prosthetic crown. For aesthetic considerations the final position and orientation of the final crown is the goal and is of upmost importance to the patient. Thus, there is a need for a system and method that reduces the amount of guesswork and skill required to properly position the finished crown. Such a method should incorporate the fundamental relationship of the final crown relative to the bone-level implant device, but should reduce skill, complexity and time required to position the implant.

### SUMMARY OF THE INVENTION

The present invention overcomes the limitations and solves problems not contemplated by the state-of-the-art by approaching implant surgery from the perspective of visualizing the exact placement of the final crown relative to the existing dentistry. Specifically, the present invention includes a tool (or device) and method that enables actual visualization of the final crown position prior to drilling and then guides the drilling process to ensure correct alignment of the drill during drilling, which translates to the correct orientation of the implant and ultimately, the crown itself.

The present invention significantly reduces the amount of skill required to perform implant surgery, reduces the time to place an implant, and provides superior aesthetic results in a more repeatable and reliable manner than currently available. Some features of the present invention include industry-standard drill bits and industry standard drills, both that can selectively couple to a spacer of the present invention. The spacer includes a cylindrical barrel, which rotates with the drill. This design is more economical to produce and maintain than current designs.

Further efficiencies are enjoyed during implant surgery, as there is a significant reduction in the number of steps, elimination of guesswork and redundant measuring devices. The device and system of the current invention make each drill operation more repeatable and precise, while at the same time reducing the skill level for such results.

The spacers can accommodate any size drill/trephine, thus the cylinder can be used as the surgeon increases the width of the drill as the osteotomy (hole for implant) is increased in size. And, the spacers are designed to be used such that they are positioned against the side of one tooth (to determine an offset) or to fit snuggle between two teeth (when centering a pilot hole).

The present method recognizes that a successful finished crown and implant surgery needs to begin and end with the precise (desired) location of the crown and that the implant location is dictated by this, which is contrary to the teachings of the prior-art, which relies on the precise location of the implant to determine the final crown position.

Another aspect of the present invention includes the use of gap keys or spacing rulers for implants away from adjacent teeth. Specific quantitative measurements are not required, instead a system matched keys and spacers simplify the selection and drilling processes.

### DRAWING

FIG. 1 is a front view of a preferred embodiment of the spacer according to the present invention.

FIG. 2 is a bottom view of the spacer of FIG. 1.

FIG. 3 is a top view of a preferred embodiment of the gap key according to the present invention.

FIG. 4 is a back view of the gap key of FIG. 3.

FIG. 5 is an illustration of a system according to a preferred embodiment of the present invention and includes a spacer, gap key and drill bit.

FIG. 6 illustrates a partial front view of a patient's teeth, gum, and jawbone with a missing tooth indicating the desired location of a prosthetic implant.

FIG. 7 illustrates a side view of along line 7-7 of FIG. 6.

FIG. 8 illustrates a top view of FIG. 6.

FIG. 9 illustrates one step according to a method of a preferred embodiment of the present invention.

FIG. 10 illustrates another step according to a method of a preferred embodiment of the present invention.

FIG. 11 illustrates yet another step according to a method of a preferred embodiment of the present invention.

FIG. 12 illustrates yet again another step according to a method of a preferred embodiment of the present invention.

FIG. 13 is a front view of a spacer in relation to a patient's teeth and illustrates a method and device according to an embodiment of the present invention.

FIG. 14 illustrates another step of the method illustrated in FIG. 13.

FIG. 15 is a front view of a spacer with a drill bit in relation to a patient's teeth and illustrates a method and device according to an embodiment of the present invention.

FIG. 16 illustrates the drill bit of FIG. 15 in relation to the jawbone.

FIG. 17 is a side view of an embodiment of the present invention and illustrates angulation of a drill bit tip relative to a patient's tooth and jaw.

### DESCRIPTION OF THE INVENTION

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

The present invention recognizes a common problem—one that is not adequately addressed in the prior art—stems from precisely locating the pilot hole in the jawbone. A number of variables interact and optimizing the pilot hole location presently rests solely on the skill and training of the surgeon or dentist placing the hole, with little aid from the tools. These variables all result from the desired crown location, which depends on the angle and axial offset of the pilot hole and the depth of the hole.

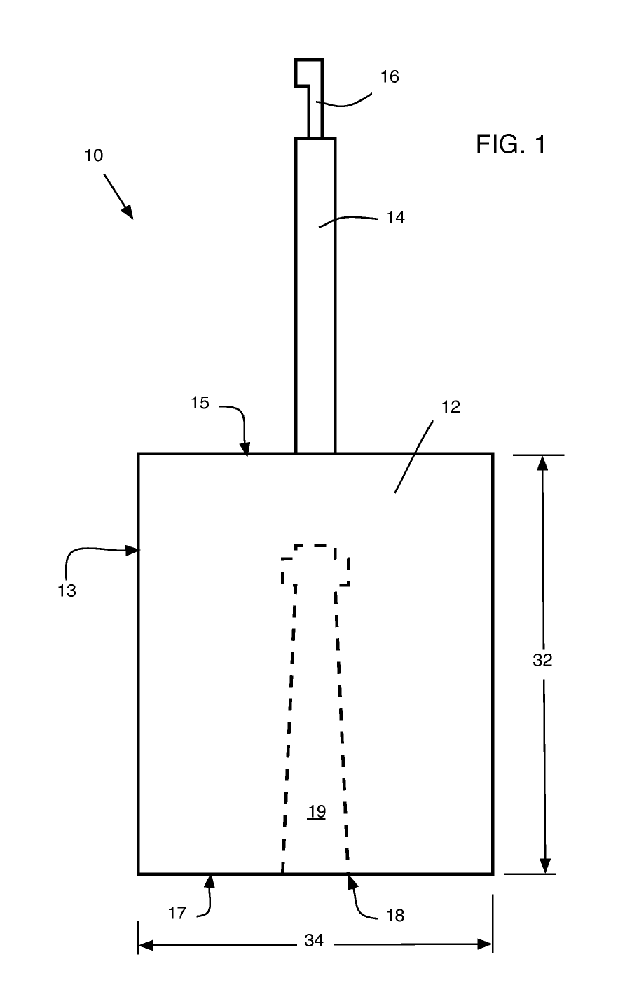

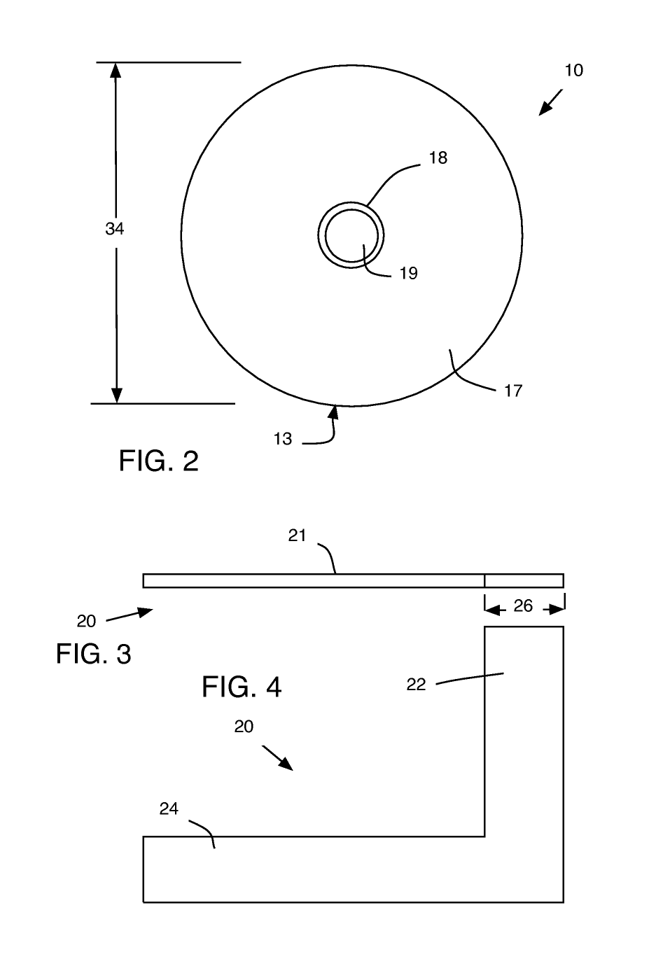

With reference to FIG. 1 a front view, and FIG. 2, a bottom view, a preferred embodiment of the present invention includes a spacer device adapted to receive a common dental drill bit for a common dental drill and the spacer device 10 adapted for dental implant surgery. Examples of suitable dental drill bits include, for example, a Model number #TREPH-2 Trephnine Drill 2.0 mm×22 mm with fit latch type available from Salvin Dental Specialties of Charlotte, N.C. 28211 U.S.A. These industry standard latch-grip devices are well-understood in the art and also include, for example, a Patterson round burr or an AB Dental Surgical kit with a number 6 round burr Product #00009340 available from Brasseler USA of Savannah, Ga.

The spacer device 10 includes a cylindrical spacer body 12 comprising at least one vertical sidewall 13 intermediate to a first body end 15 and second body end 17, the first body end coupled to a tail shaft 14 and the second body end encircling and defining an opening 18, the opening and spacer body cooperating to define hollow chamber 19 adapted to receive the common dental drill bit. The tail shaft 14 at a distal end includes a tail connector end 16 adapted to selectively couple to the dental drill. Examples of connector types include industry standard latch grips or other suitable connector features as would be well understood by those skilled in this art.

The barrel-like cylinder body 12 with vertical sidewalls has an overall outer diameter 34 and a body height 32. In a first preferred embodiment, the body height 32 is about 13.45-mm. The spacer is made of medical grade stainless steel or other comparable medical-grade material, as would be appreciated by those skilled in this art.

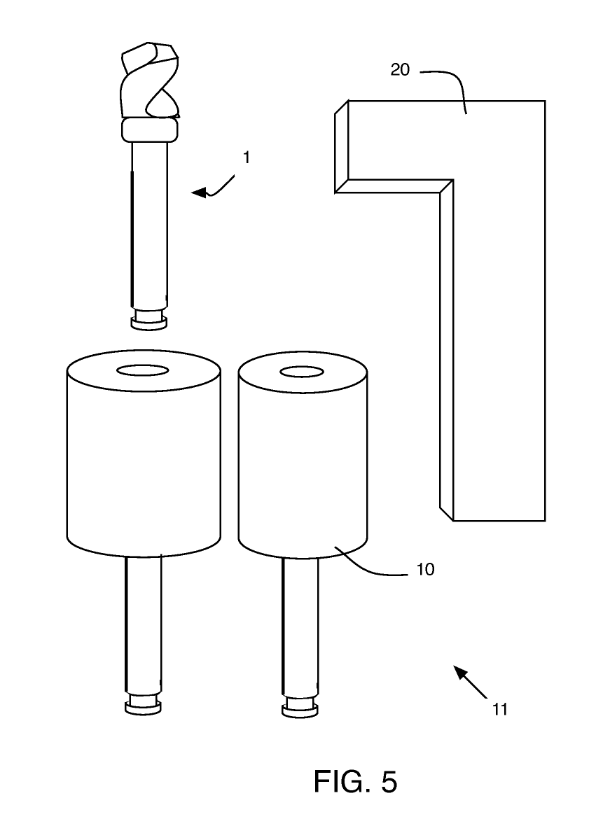

In a second preferred embodiment, the spacer of the first preferred embodiment of FIGS. 1 and 2 is included in a system 11 (as illustrated in FIG. 5, for example). This system is adapted for use with a common dental drill and the system is also adapted for dental implant surgery. The system includes at least one of the aforementioned spacer devices 10 and at least one gap key, such as the gap key 20 of FIGS. 3 and 4. The gap key 20 consists of a long flat body 21 having an insert portion arranged at about a 90-degree angle with a handle portion 24 so as to form a generally L-shaped coplanar device.

In the second preferred embodiment, the present invention includes a set or plurality of spacers, each spacer 10 includes the barrel-like cylindrical body 12 as previously described and includes a body height 32 of substantially about 13.45-mm. FIG. 5 illustrates a set 11 including a plurality of spacers 10, a drill bit, and a gap key 20. The plurality of spacers include at least 5 spacers, the first spacer has an overall outer diameter 34 of about 6.5-mm, the second spacer has an overall outer diameter of about 7.0-mm, the third spacer has an overall outer diameter of about 8.0 mm, the fourth spacer has an overall outer diameter of about 8.5-mm, and the fifth spacer has an overall outer diameter of about 9.0-mm. In alternative embodiments, the overall outer diameter dimension and body height may be altered to adapt to a particular use, such as a smaller set for patients with smaller teeth spacing, smaller oral cavities, or larger as the situation may merit, without detracting from the scope and intention of the present invention. Likewise the type of drill-bits or drill to which the spacer couples may necessitate insignificant changes in the geometry of various components, again, without detracting from the intent and scope of the present invention.

The at least one gap key 20 is preferably a set of gap keys consisting of five gap keys, each respective gap key having an insertion portion having an insertion width 26 to correspond with the overall outer diameter of the spacer. Accordingly, the first gap key includes an insertion width of about 6.5-mm, the second gap key includes an insertion width of about 7.0-mm, the third gap key includes an insertion width of about 8.0 mm, the fourth gap key includes an insertion width of about 8.5-mm, and the fifth gap key includes an insertion width of about 9.0-mm. Again, in practice or implementation the actual dimensions of the gap key and spacers may change, the important aspect is that the insertion width be matched to a particular spacer so that the surgeon or dentist is not required to take a quantitative measurement of the actual size of the space between existing dental work on the patient receiving the prosthetic crown.

Each or any one of the gap keys 20 of the preferred embodiment are similarly constructed, varying only in the true dimensions of the width of the key portion to better assess the proper location for a pilot hole for placing an implant. Thus, the gap keys are ergonomically designed rulers specific to use in the oral cavity for surgery and other dental procedures where measurements down to the half-millimeter must be made. The width of the key is clearly marked on the handle or stem 24 and corresponds to the width of the key-portion 22, which is inserted in the mouth. The surgeon or dentist can quickly now determine a specific distance in the mouth relative to a fixed point. Thus, if a surgeon wishes to start a new implant pilot hole 7 mm away from the rim of an existing implant, he selects the 7 mm gap key placing the edge of the gap key at the reference point, in this case, the rim of the existing implant. This is more useful when multiple implants are being fitted whereby the surgeon or dentist desires a precise spacing between implants but must rely on the placement of the pilot holes or existing pins already fused to the jawbone. In this way the gap key compensates for the space that an implant will take up relative to the pin already positioned and then will allow the surgeon to determine where to start the new pilot hole, which is precisely 7 mm away from that reference point (pre-existing pin). Typically, a gap key 20 or set of gap keys will be used to measure along the length of jaw bone thus the reference point will usually be at bone level. For example and by analogy, if a carpenter wanted to space a new nail exactly 7 mm from the adjacent edge of an existing feature, for example, another nail shank (not the head of the nail), then a 7 mm gap key placed against the pre-existing nail body's shank (not head) and this would precisely locate the offset required for the second (yet to be placed) nail in the block of wood. In terms of the present invention the block of wood represents the jawbone and the first nail represents the adjacent edge of existing pin or other pre-existing reference point in the patient's mouth.

In lieu of, or in addition to the gap key, the spacer 10, also referred to as an “autopilot” spacing device, can be used similar to the method just discussed in relation to the gap key of the previous paragraph. However, the spacer 10 is designed to locate using the crown of an existing tooth (or implant) as the reference point. Going back to the nail analogy, lets now say that a surgeon or dentist wanted to place a pilot hole 3.5 mm away from the rim of the nail head (not the nail shank), which represents the space a pre-existing tooth or implant would take in the patient's mouth. If a 7 mm Autopilot is placed against the nail head, then the center of the autopilot would be 3.5 mm (7 mm/2) away from the reference point. The is important because in some implant surgeries the gum tissue is not raised (this is also known in the art as a Flapless approach). The osteotomy penetrates through the gum tissue. Therefore the crown of the adjacent tooth needs to be used as a reference point. This is particularly important when the implant will become the last tooth on that side. This means the spacer 10 can't be fit between two crowns for centering. It only has the one crown for reference.

In a preferred embodiment, colored graduations on the probe instrument facilitate use. Other markings include ISO markings or other indicia devised to enable the dentist to rapidly and accurately determine the optimally sized spacer and implant for the particular location on a given patient.

In each of the preferred embodiments, each respective spacer 10 include a tail stock 14 having a connector end 16, which adapts to selectively and releasably couple to an industry standard dental-drill.

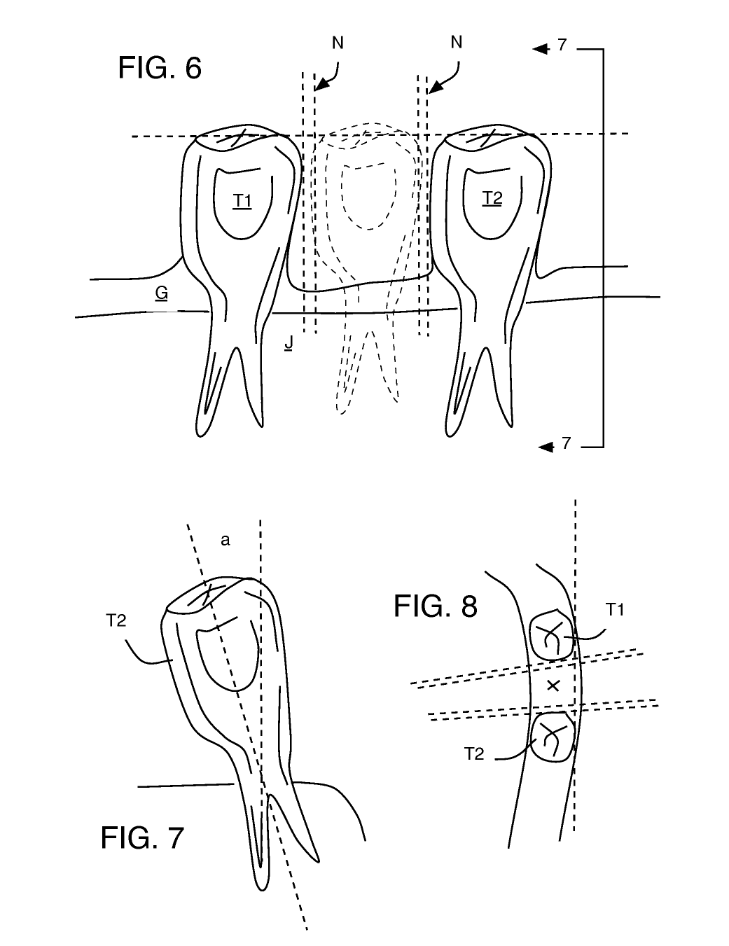

FIGS. 6, 7, and 8 illustrate generally the art of prosthetic crown placement. For example, FIG. 6 represents a front view of a partial set of teeth with a missing tooth indicated by a dashed line. The existing teeth T1 and T2 may be natural teeth, implants with crowns or other structures as would be appreciated by those skilled in this art. From this illustration, it should be appreciated that the teeth T1 and T2 are well rooted in the jawbone J and surrounded by healthy gum tissue G. From the teachings of the prior-art, a desired spacing between the future crown and adjacent teeth is at an offset N of about 1.5-mm on each side. Thus, by determining the size of the gap and the desired offset for each side of the crown, a specific size and shaped crown may be selected.

Additional considerations in prosthetic crown placement, as FIGS. 7 and 8 illustrate, include the fore-aft and left-right position of the crown and the pitch/angulation/from vertical of the crown. As mentioned, the prior-art teaches that the location of the implant will drive the final position of the crown. While this is still true, the present invention includes a device and method that greatly reduces the error and guesswork with respect to the prior-art teaching.

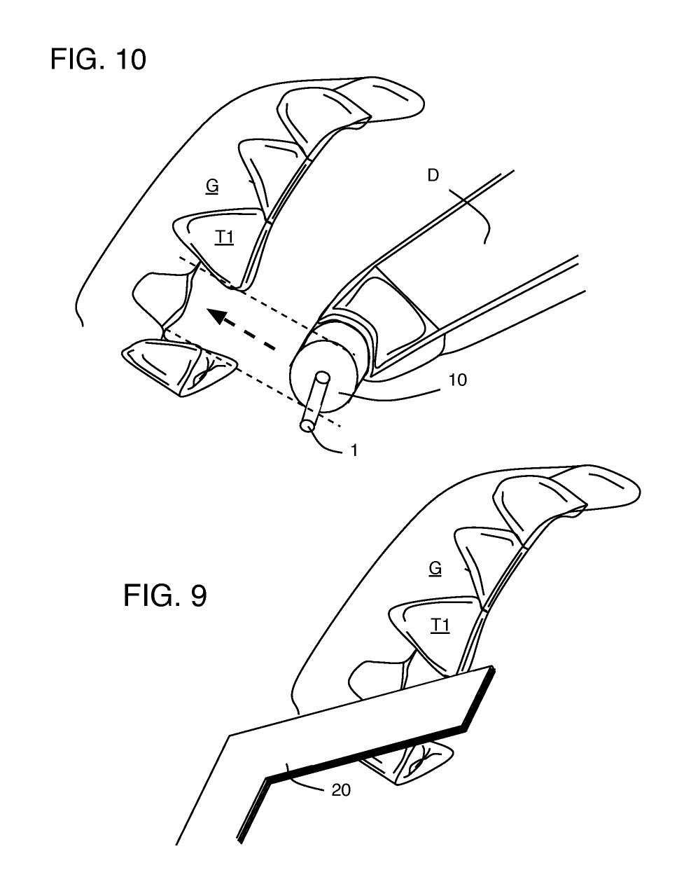

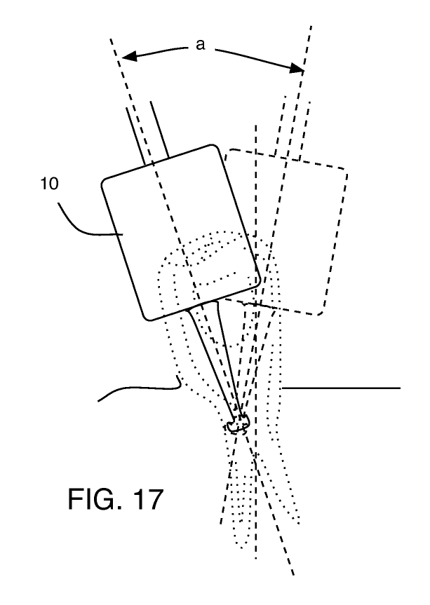

FIGS. 9-17 illustrate various preferred methods using a spacer 10 of the present invention. And, in contrast to the conventional teaching, a preferred method does not quantitatively measure the gap and place the pilot hole based on calculations of the crown position, but rather uses a visual representation of the crown at all stages and uses comparative devices that eliminates quantitative measurements. For example, FIG. 9 shows a gap key 20 being inserted in a space between two existing teeth 2. In practice, this method involves the dentist or surgeon selecting a first gap key from a set of gap keys and gently inserting the key between the teeth and observing if the gap key fits comfortably or is loose or tight. Then, if the key is loose, selecting the next size up and if it is tight selecting the next size down. This process is repeated until the dentist or surgeon is confident the correct size key has been selected. Next, the surgeon or dentist simply selects the corresponding spacer 10 (see, e.g. FIG. 10) that has an overall outer diameter that matches the insertion width of the gap key. The dentist or surgeon need not measure the size, but rather make a simple comparative determination by looking at the code (color, ISO graduation, or other marking) on the gap key and then selecting the correspondingly marked spacer.

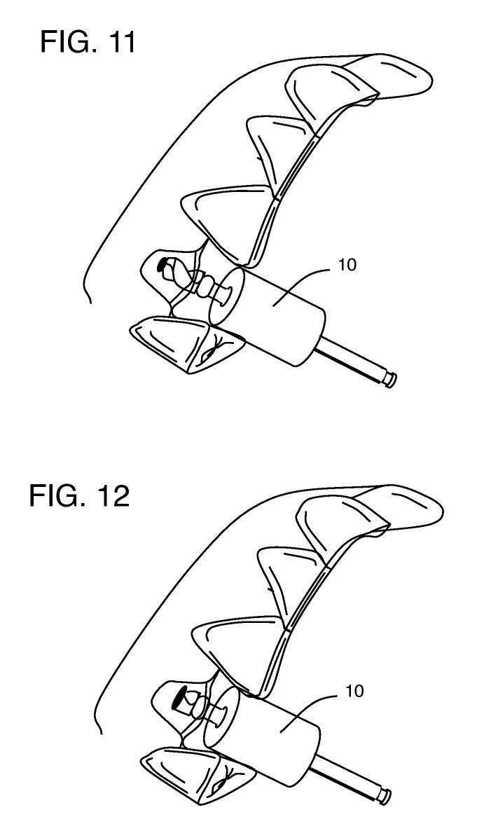

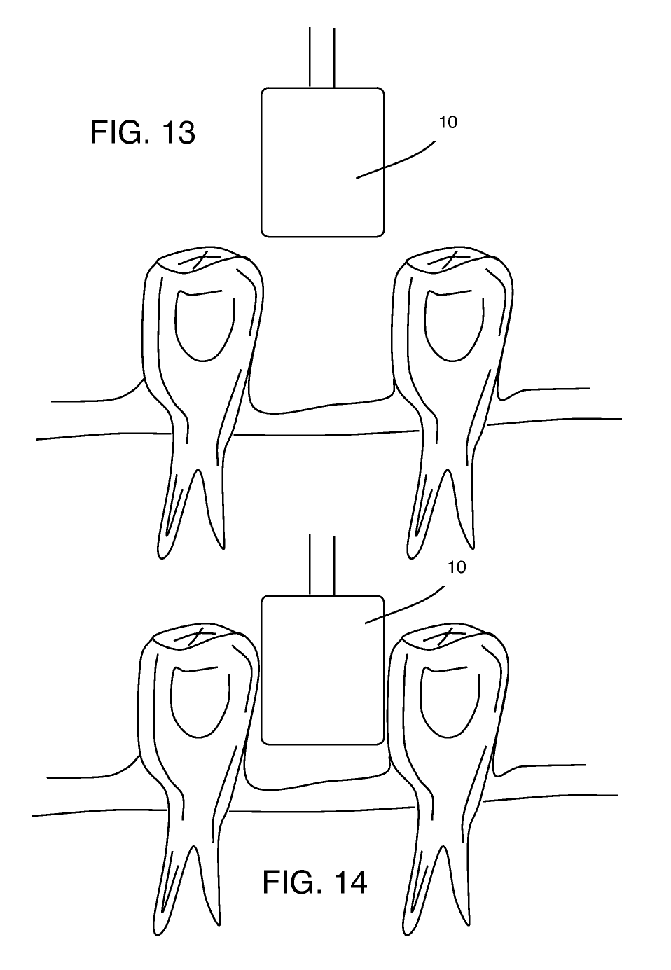

With the correct spacer selected, there is no left-right movement of the drill bit and the dentist surgeon can use the spacer to visualize the angulation and fore-aft position of the crown before drilling. By a simple visual alignment of the spacer, the dentist can begin drilling. If needed (as FIGS. 11 and 12 show, for example) drill bits may be exchanged out of the spacer and a progressively larger hole can be fashioned, with each drilling sequence being assured to be precise and repeatable from the guide provided by the spacer 10.

Using the spacer 10 without a drill bit coupled to it can further enhance visualization of the placement of the crown. For example, as FIGS. 13 and 14 show, the spacer can be attached to a drill or manipulated by hand to assess the size, clearances, and orientation of a prosthetic crown prior to drilling.

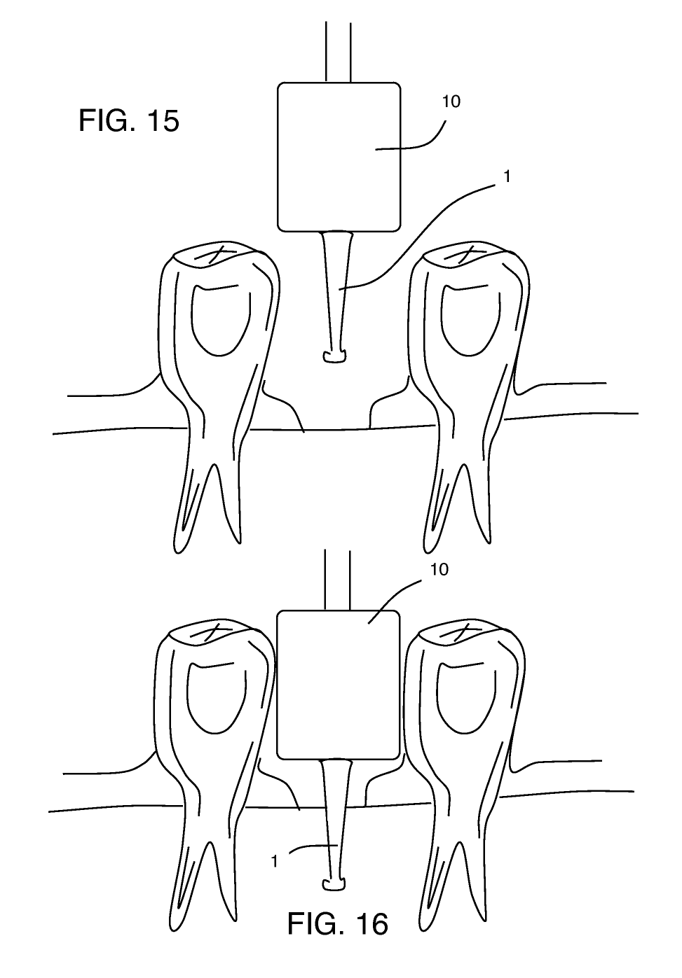

FIGS. 15-17 show how the spacer 10 with coupled drill bit fits between existing teeth. Here some skill is required to visualize (using the spacer) the miseal-distal and buckle-lingual and angulation of the implant relative to existing structure (natural teeth, other implants, etc.). However, the spacer reduces the guesswork considerably as the pilot hole location is centered on the spacer and the spacer is sized to fit between existing structure.

Although the invention has been particularly shown and described with reference to certain embodiments, it will be understood by those skilled in the art that various changes in form and detail may be made without departing from the spirit and scope of the invention.

I claim:

1. A system adapted for use with a common dental drill having at least one drill bit and the system adapted for dental implant surgery, the system comprising:
at least one spacer device;
and wherein the at least one spacer device comprises
a cylindrical spacer body comprising at least one vertical sidewall intermediate to a first and second body end, the first body end coupled to a tail shaft and the second body end encircling and defining an opening, the opening and spacer body cooperating to define hollow chamber adapted to receive the dental drill bit and wherein the tail shaft at a distal end includes a tail connector end adapted to selectively couple to the dental drill.

2. The system of claim 1 further comprising:
at least one gap key.

3. The system of claim 2 wherein the gap key further comprises:
an insert portion coupled to a handle portion, the handle portion arranging at about perpendicular to the insert portion and the insert portion and handle portion arranging substantially in a common plane, the insert portion have an insert width.

4. The system of claim 1 wherein the cylindrical spacer body further comprises:
a first outside diameter.

5. The system of claim 2 further comprising:
the gap key further comprising an insert portion coupled to a handle portion, the handle portion arranging at about perpendicular to the insert portion and the insert portion and handle portion arranging substantially in a common plane, the insert portion have an insert width.

6. The system of claim 2 wherein:
the at least one spacer device comprises a first spacer device and a second spacer device; and
the at least one gap key comprises a first gap key and a second gap key; wherein
both the first and second spacer devices comprise a cylindrical spacer body comprising at least one vertical sidewall intermediate to a first and second body end, the first body end coupled to a tail shaft and the second body end encircling and defining an opening, the opening and spacer body cooperating to define hollow chamber adapted to receive the dental drill bit and wherein the tail shaft at a distal end includes a tail connector end adapted to selectively couple to the dental drill and the first spacer device further comprises a first outside diameter and the second spacer device further comprises a second outside diameter; and
both the first and second gap keys comprise an insert portion coupled to a handle portion, the handle portion arranging at about perpendicular to the insert portion and the insert portion and handle portion arranging substantially in a common plane, and the first gap key insert portion further comprises a first insert width and wherein the second gap key insert portion further comprises a second insert width whereby the first insert width corresponds to the first spacer first outside diameter and the second insert width corresponds to the second spacer device second outside diameter.

7. The system of claim 1 wherein the dental drill bit is coupled to the spacer device.

8. An improved method for locating a crown of a dental implant and orienting a pilot hole for the implant using dental drill bits and a dental drill and using existing structure in the patient's mouth, the method comprising:
providing at least one gap key, the gap key comprising an insert portion having a first insert width; or
providing at least one spacer device having an outside diameter corresponding to the first insert width; or
providing both at least one gap key and at least one spacer device.

9. The method of claim 8 further comprising:
using the spacer as a visual representation of the crown of a newly desired dental implant;
placing the spacer adjacent to an adjacent edge of the existing structure to determine the offset from the existing structure for a new pilot hole;
positioning the tip of the drill bit against the jaw bone and adjusting the angulation of the bit to correspond with the final orientation of the newly desired crown and positioning the bit along the lingual-misial axis; and
drilling the pilot hole.

10. The method of claim 8 further comprising:
using the gap key to determine a specific distance in the mouth relative to the existing structure wherein the existing structure is a fixed point;
selecting at least one gap key having an insertion width corresponding to the desired offset from the fixed point;
placing the edge of the gap key at the fixed point; and
locating the dental drill bit adjacent to the gap key so that the gap key is intermediate to the drill bit and the fixed point.
